(19) United States
(12) Patent Application Publication
(10) Pub. No.: US 2006/0005225 A1
(43) Pub. Date: Jan. 5, 2006

(54) Multimedia network video device

(76) Inventor: Juen Tien Peng, Chung Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/880,580

(22) Filed: Jul. 1, 2004

(51) Int. Cl. H04N 7/173; H04N 7/16

(52) U.S. Cl. 725/131; 725/139; 725/151; 725/100

(57) ABSTRACT

A multimedia network video device includes a CPU, an I/O module connected to the CPU for transmitting data to or from CPU, a video capturing module for capturing video data and transmitting the video data to the CPU for processing, an audio capturing and playing module connected to the CPU for capturing and playing audio data, a function key module for controlling function status of the CPU, a video driving and displaying module for driving video data processed by the CPU and transmitting the video data to a display device thereof for playing, a CD read device for receiving a CD and reading data from the CD and then transmitting the data to the display device for playing, and a power supply module for providing power to the above modules. The CPU processes data transmitted from the above modules.

### BACKGROUND OF THE INVENTION

1. Field of the Invention

The present invention relates to a network video device, and particularly to a multimedia network video device.

2. Prior Art

As development of communication technology, it seems that distance between people in different places gets shorter and shorter. When you want to contact a person far away from your place, you may traditionally use a telephone or a fax. However, you cannot see his or her face and action through the traditional manner.

To encounter the above problem, a video conference is provided through a network. People at different places can see and talk with each other through the video conference. Therefore, the video conference makes communication easy for people at different places, which improves communication efficiency and reduces communication cost.

However, since a conventional network video device is connected to the network in wire communication, the video conference can only be hold at some regular places such as at office or at home for connecting to the network. Therefore, you cannot contact people through the video conference when you are not at the regular places. So, it is not convenient to use the conventional network video device at some extent.

Furthermore, the conventional network video device has a single function of holding a video conference. However, since people need more and more digital products with different functions nowadays, it is usually inconvenient for a user to take with many digital products for providing the different functions. So, it is required a multifunctional product.

### SUMMARY OF THE INVENTION

Accordingly, an object of the present invention is to provide a multimedia network video device, which is combined with a compact disc (CD) read device, a network video device and an LCD module, and uses one CPU to process multimedia audio and video (AV) data thereby expanding functions of the network video device, whereby the multimedia network video device is multifunctional.

Another object of the present invention is to provide a multimedia network video device, which has a function of a multimedia player but does not need to connect to an external CD-ROM, whereby the multimedia network video device is convenient to use and saves space.

Another object of the present invention is to provide a multimedia network video device, which is connected to a wireless network, thereby being portable and mobile.

Another object of the present invention is to provide a multimedia network video device, which is connected with an external AV signal generator, and plays external AV signals through a display device thereof, whereby the multimedia network video device is convenient to use.

Another object of the present invention is to provide a multimedia network video device, which is multifunctional thereby reducing cost relative to having the functions separately.

To achieve the above-mentioned objects, a multimedia network video device in accordance with the present invention includes a CPU, an I/O module connected to the CPU for transmitting data to or from CPU, a video capturing module for capturing video data and transmitting the video data to the CPU for processing, an audio capturing and playing module connected to the CPU for capturing and playing audio data, a function key module for controlling function status of the CPU, a video driving and displaying module for driving video data processed by the CPU and transmitting the video data to a display device thereof for playing, a CD read device for receiving a CD and reading data from the CD and then transmitting the data to the display device for playing, and a power supply module for providing power to the above modules. The CPU processes data transmitted from the above modules.

Other objects, advantages and novel features of the present invention will be drawn from the following detailed embodiment of the present invention with attached drawings, in which:

### BRIEF DESCRIPTION OF THE DRAWINGS

FIG. 1 is a chart showing a multimedia network video device of the present invention; and

FIG. 2 is a schematic view showing two multimedia network video devices of the present invention being connected to each other through network.

### DESCRIPTION OF THE PREFERRED EMBODIMENT

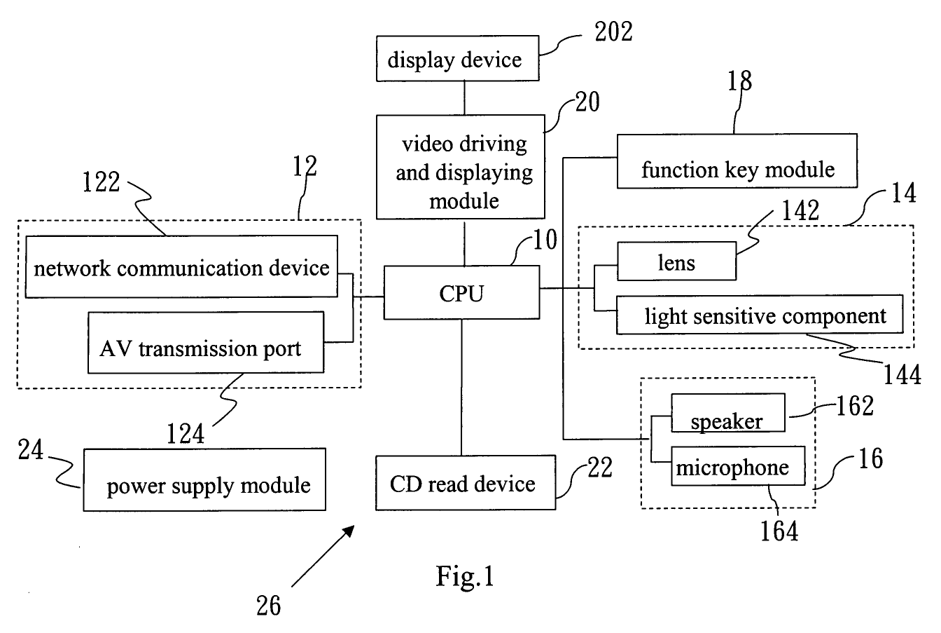

Referring to FIG. 1, a multimedia network video device of the present invention includes a central processing unit (CPU) 10 which is connected with an input/output (I/O) module 12, a video capturing module 14, an audio capturing and playing module 16, a function key module 18, a video driving and displaying module 20, and a CD read device 22. The I/O module 12 is for transmitting data between an external device and the CPU 10 and includes an audio and video (AV) transmission port 124 which is an AV terminal in this embodiment, and a network communication device 122. The network communication device 122 is connected to a wireless network or a wire network, such as Ethernet. The video capturing module 14 is for capturing video data and transmit the video data to the CPU 10 and includes a lens 142 and a light sensitive component 144. The audio capturing and playing module 16 includes a speaker 162 for audio output and a microphone 164 for audio input. The function key module 18 is used to control function status of the CPU 10 through function keys thereof. The video driving and displaying module 20 receives video data processed by the CPU 10 and then drives a display device 202 thereof to play the video data. The CD read device 22 is controlled by the CPU 10. The CD read device 22 reads data from a CD received therein and then plays the data through the display device 202. A power supply module 24 is used to provide power to the above modules.

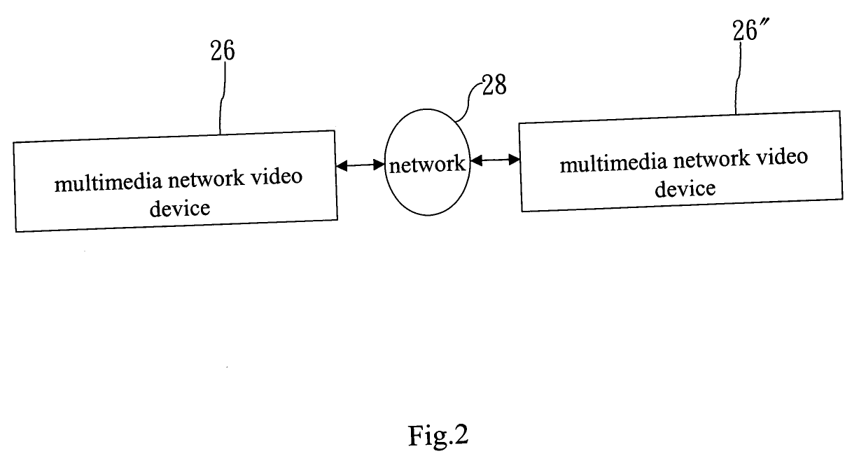

Referring to FIG. 2, when the multimedia network video devices 26, 26″ of the present invention are connected to each other through a network 28 for having a video conference, a network video conference function of the multimedia network video device 26 is selected through the function key module 18. The CPU 10 processes video data captured by the lens 142 and the light sensitive component 144 of the video capturing module 14 and audio data input by the microphone 164 of the audio capturing and playing module 16. The multimedia network video device 26 connects to the network 28 through the network communication device 122 with a built-in fixed IP address or a virtual IP address and transmits data to another multimedia network video device 26″. At the same time, the multimedia network video device 26 receives AV data from the another multimedia network video device 26″ and then transmits the AV data to the CPU 10 for processing. The processed AV data are transmitted to the video driving and displaying module 20 and the audio capturing and playing module 16. The video driving and displaying module 20 transmits video data to the display device 202 for display. The display device 202 is an LCD in this embodiment. The audio capturing and playing module 16 transmits audio data to the speaker 162 for playing. The speaker 162 may be a trumpet or an earphone.

When the multimedia network video device 26 is used to play CD, a CD playing function is selected through the function key module 18 and then the CD which may be a VCD or a DVD is inserted to the CD read device 22 for reading AV data. The AV data are transmitted to the CPU 10 for processing and then the processed AV data are transmitted to the display device 202 for display through the video driving and displaying module 20.

When the multimedia network video device 26 is used to play AV signals from an external signal generator, a function of playing external AV signals is selected through the function key module 18 and the external AV signal generator is connected to the AV transmission port 124. The AV signals from the external AV signal generator are transmitted to the CPU 10 for processing and then the processed AV signals are transmitted to the video driving and displaying module 20 for displaying through the display device 202.

As described above, the multimedia network video device of the present invention is combined with a CD read device, a network video device and an LCD module, uses one CPU to process multimedia AV data, is connected to a network through wireless communication, and is connected to an external AV signal generator whereby the multimedia network video device is multifunctional, portable, mobile and convenient to use.

It is understood that the invention may be embodied in other forms without departing from the spirit thereof. Thus, the present examples and embodiments are to be considered in all respects as illustrative and not restrictive, and the invention is not to be limited to the details given herein.

1. A multimedia network video device, comprising a CPU;
an I/O module, connected to the CPU for transmitting data to or from CPU;
a video capturing module, for capturing video data and transmitting the video data to the CPU for processing;
an audio capturing and playing module, connected to the CPU for capturing and playing audio data;
a function key module, for controlling function status of the CPU;
a video driving and displaying module, for driving video data processed by the CPU and transmitting the video data to a display device thereof for playing;
a CD read device, for receiving a CD and reading data from the CD and then transmitting the data to the display device for playing; and
a power supply module, for providing power to the above modules;
Wherein the CPU processes data transmitted from the above modules.

2. The multimedia network video device as claimed in claim 1, wherein the I/O module includes a network communication device and an AV transmission port.

3. The multimedia network video device as claimed in claim 2, wherein the AV transmission port is an AV terminal.

4. The multimedia network video device as claimed in claim 2, wherein the AV transmission port is connected with an external AV signal generator.

5. The multimedia network video device as claimed in claim 2, wherein the network communication device is connected to a wire network or a wireless network.

6. The multimedia network video device as claimed in claim 5, wherein the wire network is Ethernet.

7. The multimedia network video device as claimed in claim 2, wherein the network communication device is connected to a network through a built-in fixed IP address or a virtual IP address.

8. The multimedia network video device as claimed in claim 1, wherein the video-capturing module includes a lens and a light sensitive component.

9. The multimedia network video device as claimed in claim 1, wherein the audio capturing and playing module includes a speaker and a microphone.

10. The multimedia network video device as claimed in claim 9, wherein the speaker is a trumpet or an earphone.

11. The multimedia network video device as claimed in claim 1, wherein the display device is an LCD.

12. The multimedia network video device as claimed in claim 1, wherein the CD is a VCD or a DVD.
